(19) United States
(12) Patent Application Publication
(10) Pub. No.: US 2012/0277908 A1
(43) Pub. Date: Nov. 1, 2012

(54) SYNERGETIC ROBOTIC SYSTEM

(75) Inventors: Edmundo Manuel Nabais Nobre, Lisboa (PT); Fernando Manuel Nabais, Lisboa (PT); Maria Cristina Frazão Pissarra Gouveia, Lisboa (PT)

(73) Assignee: YDreams - Informatica, S.A., CAPARICA (PT)

(21) Appl. No.: 13/459,824

(22) Filed: Apr. 30, 2012

Related U.S. Application Data
(60) Provisional application No. 61/480,099, filed on Apr. 28, 2011.

(51) Int. Cl. G06F 19/00; F21S 2/00

(52) U.S. Cl. 700/245; 700/259; 362/458

(57) ABSTRACT

A robotic system is disclosed that includes a mobile device, a docking station, and a software application hosted in the mobile device. The the mobile device is physically lodgeable in the docking station. The software application is hosted in the mobile device. The mobile device and the docking station enter a coordinated action mode via the software application when the mobile device is physically lodged in the docking station. And the software application is configurable with different profiles.

### TECHNICAL FIELD

This disclosure is in the general field of robotics and automated systems.

### BACKGROUND

Robotics is a technologically active area. The integration of a mobile device with further elements to make a robot is present in the prior art. The present disclosure describes novel features that combine mobile devices with robotic capabilities.

### SUMMARY

In accordance with the teachings of the present disclosure, disadvantages and problems associated with existing marketing information systems and methods have been reduced.

According to one aspect of the invention, there is provided a robotic system that includes a mobile device, a docking station, and a software application hosted in the mobile device. The mobile device is physically lodgeable in the docking station. The software application is hosted in the mobile device. The mobile device and the docking station enter a coordinated action mode via the software application when the mobile device is physically lodged in the docking station. And the software application is configurable with different profiles.

### BRIEF DESCRIPTION OF THE DRAWINGS

FIG. 1 describes a specific embodiment of this disclosure.

FIG. 2 describes the initialization of a software application according to this disclosure.

FIG. 3 is a scheme for a robotic lamp, in accordance with this disclosure.

### DETAILED DESCRIPTION

Processor power has been increasing continuously, current-day mobile devices processors already being adequate for general-purpose computing, as exemplified by Citrix' Nirvana Phones.

Additionally, smartphones have components that extend both the sensing and expression capabilities of regular cell phones. Thus, smartphones have been regarded as useful in the do-it-yourself (DYI) robot world. An example of such an initiative is the cellbots project at http://www.cellbots.com/, where a cell phone is coupled to other electronic means for performing a separate function to that of the smartphone itself.

The present disclosure explores aspects of composition between mobile devices and their separate robotic extension, inasmuch as the mobile device offers several capabilities that can be composed with the capabilities of other devices in a synergetic fashion—by either 2 separate basic functions achieving a third composite function distinctive from the nature of the 2 basic functions—or simply by a third function achieving a scope that is not achievable within any of the 2 basic functions.

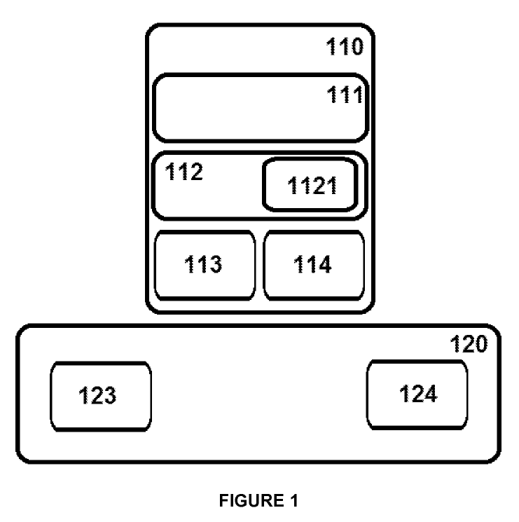

FIG. 1 describes a mobile device 110, comprising processor 111, memory 112, sensors 113, and actuators 114.

Memory 112 comprises a software application 1121.

A dock 120 comprises sensors 123 and actuators 124.

Software application 1121 may be the firmware of mobile device 110, or it may run over a general-purpose operating system, such as Windows, Android, iOS, Symbian or MeeGo.

Software application 1121 is configured to access at least one of sensors 113, sensors 123, actuators 114 and/or actuators 124, and any set thereof.

Software application 1121 is interactive between sensors and actuators, being configured to set off an actuator, or any set of actuators, in response to data from a sensor or any set of sensors.

Sensor data is handled by software application 1121 in configuring operation of actuators.

The processing of sensor data by software application 1121 may vary in complexity.

In a simple embodiment, a sensor may trigger an actuator by simple lookup table query. This can be the case for a presence sensor that activates a presence actuator.

In a complex embodiment, data from any set of available sensors is matched to patterns in a database, the same data being able to match more than one pattern, and patterns triggering dynamic behaviors in the actuators that may have coordinated action or not.

This can be the case for when a proximity sensor in dock 120 detects an object within its range, and simultaneously a sound sensor in mobile device 101 detects a voice that is saying “come closer”. The default behavior assigned to the data from the proximity sensor may be ‘stop all motion’, and the default behavior for detecting a “come closer” language pattern may be to ‘move in the direction of motion’, as detected by a video sensor in mobile device 110.

In this case, there is conflict in behaviors, which can be resolved by assigning one behavior priority over the other.

Hierarchy of behaviors may be resolved by nesting behaviors in a tree. By nesting behavior routines in a tree, great parallelism can be achieved in code execution, and the propagative nature of the tree is of use in programming intelligence.

In another embodiment, software application 1121 may include a behavior that maximizes a set of parameters, given a set of sensor data and an entire library of behaviors, applying the behaviors that, as an hierarchically resolved set, provide for maximum parameter value given the set of sensor data.

Behaviors can also be assigned to sensor data patterns by a process involving calculus of probability—if sensor data does not match a pattern in a database, it can still be used by:
analyzing sub-sets of the data for pattern matching;
synthesizing the data with other data for pattern matching;
applying extrapolation algorithms to the data so as to extend it into a probable evolved set which pattern(s) can then be matched with the database.

Software application 1121 may also apply behaviors to the absence of sensor data, such as activation of a roaming mode after a timeout.

Software application 1121 may include a module to manage the energy, for instance simply charging the mobile device battery when it is docked, or averaging the charge between the mobile device battery and the docking station battery, when the docking station is equipped with a battery separate from the smartphone battery.

Dock 120 can be of different configurations, but it is configured to at least:
hold mobile device 110 in place; and
communicate with mobile device 110, and specifically with software application 1121 that runs in memory 112 of mobile device 110.

Communication may be done through a physical connection, or reliant on wireless technologies, such as Bluetooth or ZigBee.

Smartphones are mobile devices that are by definition equipped with communication capabilities, and the dock must include a communication port that is configured to allow the functions described below.

Dock 120 comprises a power source, which may be provided by:
connection to an external power socket;
internal battery;
the battery of mobile device 110; or
any combination thereof, which functions to power sensors 123 and actuators 124 of dock 120, and may also function to charge any of the batteries by resorting to the other battery or—in particular the battery of mobile device 110 may be charged from the battery of dock 120, or from the external power socket connection of dock 120.

Motion can be achieved through the use of electric motors, that can be powered either through the battery of the smartphone, or through the dock, when it has separate power.

The motion produced by electric motors, e.g. rotation of an axis, can be mechanically transformed in more than one kind of motion, such as direct or indirect rotation, including the rotation of wheel axles. Motion can include any 3D degree of freedom, and moreover can be relative or absolute.

Relative motion can be defined as when the system of the mobile device and the dock can move itself from a first configuration in 3D space to a second configuration in 3D space, wherein the second configuration has partial intersection with the first configuration.

Absolute motion can be defined as when the system of the mobile device and the dock can move itself from a first location in 3D space to a second location in 3D space that has no intersection with the first location.

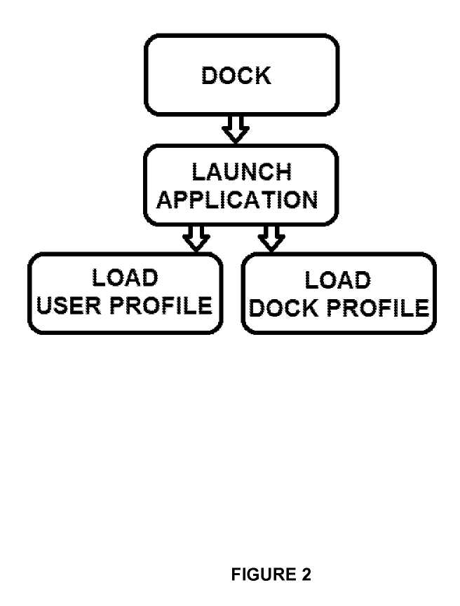

FIG. 2 shows a process of launching software application 1121 configured to detect the event of mobile device 110 being docked in dock 120, and consequently launching the software application, that loads both a user profile and a dock profile.

Software application 1121 can be launched from either a call from an external application, or it may always run in minimized/invisible state when the mobile device is not docked, and in maximized/visible state when the mobile device is docked.

The mode of detection for the docking event is immaterial to this disclosure as long as software application 1121 can at any time query the docking state of mobile device 110.

By use of profiles, similar systems with different user profiles can operate in a manner distinctive from one another. For instance, a user profile that includes a preference for “no sound” can disable the use of all actuators 114 and/or 124 that are sound actuators, whilst a profile that does not include a preference for sound can enable actuators 114 and/or 124 that are sound actuators.

The dock profile also influences operation; for instance, a dock profile that includes information that the dock has absolute motion capability on a surface, through 3 degrees of freedom of motion: surge, sway and yaw, can enable a roaming module in the application that moves the system to any point on the surface; a dock profile that includes information that the dock has only the motion capability of varying its positional height through 1 degree of freedom of motion: heave, will not enable the module that moves the system on the surface, and can enable another module instead, for instance an observer module, in which the system is always kept within sight of an object, even when obstacles come into the line of sight of the object, causing it to adjust its height to maintain sight thereof.

Software application 1121 can be configured to convey telepresence of a remote user, since telepresence relays basically on the presence of a display and/or a speaker, and optimally also in the presence of a video sensor, sound sensor, and motion capabilities.

Software application 1121 may make a remote user present by conveying:
the face of the remote user or another graphical representation of the user through the mobile device screen;
the voice of the remote user or another audio representation of the user, e.g. a set of songs, through audio actuators, on the mobile device and/or the dock;
video acquired by cameras from the system to the remote user;
sound acquired by sound sensors to the remote user;
and enabling the remote user to control the motion of the system.

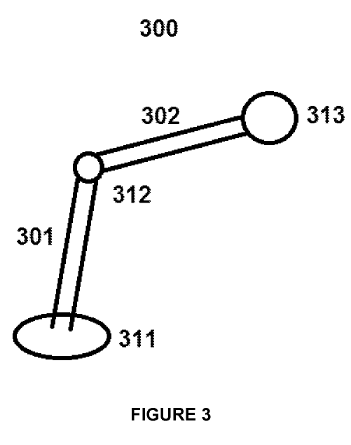

FIG. 3 shows a preferred embodiment to this disclosure. In FIG. 3, a lamp 300 is comprised of 2 axles 301 and 302, a base 311 at the end of one of the axles, a joint 312 between the axles and a terminal section 313 at the end of the other axle.

Joint 312 allows for at least one degree of freedom of motion. Base 311 can be either a rigid structure, or a structure that functions, wholly or partially, as a joint, or the structure of base 311 may include a separate joint attached to its structure, thereby affording axle 301 with at least one degree of freedom of motion.

Thus, lamp 300 can have at least 2 degrees of freedom of motion, as long as the motion that is afforded to axles 301 and 302, respectively, is not along the same abstract axis.

The specification of number of axles and associated joints to the lamp structure functions to provide it with enough degrees of freedom of motion to accomplish a task. Thus, a task requiring “n” degrees of freedom of motion will use an embodiment with will have a “n/j” number of joints, in which “j” is the number of degrees of freedom of motion per joint, assuming that joints have a uniform number of degrees of freedom of motion.

The lamp is configured to hold a smartphone on its structure. For instance, the smartphone can be held at terminal section 313.

The sensors for the system of the lamp and the smartphone comprise:
smartphone sensors, which include a microphone, and can include one or more video cameras, a location module (e.g., Global Positioning System (GPS), Galileo, Global Navigation Satellite System (GLONASS)), inclinometer and gyroscope; and
lamp sensors, which can include proximity sensors, that can be used in prevention of collisions with objects in the vicinity of the system.
The actuators for the system of the lamp and the smartphone comprise:
smartphone actuators, which include the smartphone speaker(s) and display screen, and can also include vibrating modules; and
lamp actuators, which include light sources, and can include sound actuators further to the smartphone speakers, and motion devices or parts.
Light source actuators can exist in different places of the structure of the lamp, and may emit different types of light, such as:
signaling light;
focus light; and
ambient light;
wherein:
signaling light is a type of light that can be perceived from a distance but which does not affect any object other than the source of light itself;
focus light is a type of light that affects the source of light itself, and also affects objects in a limited direction relative to the source of light;
ambient light is a type of light that affects the source of light itself, objects in a significant radius relative to the source of light regardless of direction, and moreover the environment of the system itself; the radius of the ambient light relative to the source of light being always greater than the largest linear dimension of the system of the lamp and the smartphone.

Light source actuators may provide light that is either constant or intermittent in presence and intensity. The pattern of intermittence may be meaningful—for instance, when a sound actuator is rendering a song, the light source actuator may, by means of the software application, be turned on and off with each beat of the music, or the light source actuator may emit high-intensity light to the beat of the music, and otherwise be in a low-intensity light state.

Unlimited synesthetic compositions of light and sound may be embodied depending on actuators and software application 1121. Sensors can also be used for auto-feedback, but this may be redundant insomuch as software application 1121 has internal control data for all actuators.

In another embodiment, signaling light may be used to indicate where the system is located, for easy access in the dark; and also to indicate moving parts of the lamp structure when they are moving so that users can interpret them as lights that are warning of motion.

In a simultaneous implementation of both these uses of signaling light, they could either be each in a separate color, and/or the indication of motion could be accompanied by a sound, in order for them to be able to be distinguished.

In a specific implementation of this preferred embodiment, a user may enter a dark room, in which a lamp according to this disclosure is placed.

The user can see the lamp in the room since its frame is delineated in light blue signaling light. When the user approaches the lamp, a section of it pulses with yellow signaling light at a place in its frame where a pressure switch is located.

As the user presses the area pulsing with yellow signaling light, the lamp generates ambient light so that the user can see the room.

The user is carrying a smartphone that is turned on and has an application that is compatible with the lamp.

The smartphone and the lamp communicate wirelessly and a section of the lamp pulses with yellow light in an inner-bound concentric pattern.

The user takes the smartphone and places it against the new pulsating yellow light, where it is then secured in the structure of the lamp. The smartphone's screen changes to a smiling emoticon and the lamp's axles move, placing the smartphone in a height approximate to the face of the user, who has sat down by the lamp, and at a distance that enables the user to see the smartphone screen clearly.

As a call is made to the smartphone, the smartphone's screen changes from a smiling emoticon to the standard smartphone screen, and the lamp structure reverts to its standard position, stopping as it detects an arm of the user in its way, and then using just yellow signaling light by the smartphone, this time in an outer-bound concentric pattern.

Depending on the size and contextual placing of the structure of the lamp, the user may configure the application through the smartphone so that the entire structure exhibits a dynamic pattern in a bright color when the structure of the lamp is moving.

The disclosed embodiments vie to describe certain aspects of the disclosure in detail.

Other aspects may be apparent to those skilled in the state-of-the-art that, whilst differing from the disclosed embodiments in detail, do not depart from this disclosure in spirit and scope.

What is claimed is:

1. A robotic system, comprised of:
a mobile device;
a docking station; and
a software application hosted in the mobile device; wherein:
the mobile device is physically lodgeable in the docking station;
the software application is hosted in the mobile device;
the mobile device and the docking station enter a coordinated action mode via the software application when the mobile device is physically lodged in the docking station; and
the software application is configurable with different profiles.

2. A system according to claim 1, wherein the mobile device is a smartphone.

3. A system according to claim 1, wherein the docking station includes electric power.

4. A system according to claim 3, wherein the source for the electric power of the docking station is an electric battery.

5. A system according to claim 1, wherein the docking station includes proximity sensors.

6. A system according to claim 1, wherein the docking station includes electric motors.

7. A system according to claim 6, wherein the electric motors power wheels.

8. A system according to claim 1, wherein the different profiles for the software application are of the type:
user profiles; and
docking station profiles.

9. A system according to claim 1, wherein the software application:
collects sensor data;
interprets sensor data; and
assigns behaviors to actuators based on the interpretation of sensor data.

10. A system according to claim 1, wherein the software application assigns behaviors to actuators based on user profiles and docking station profiles.

11. A system according to claim 1, wherein behaviors are organized in hierarchical trees.

12. A system according to claim 1, wherein the software application enables telepresence by conveying:
the face of a remote user or another graphical representation of the user through the mobile device screen;
the voice of the remote user or another audio representation of the user through audio actuators, on the mobile device and/or the dock;
video acquired by cameras from the system to the remote user;
sound acquired by sound sensors to the remote user;
and by enabling the remote user to control the motion of the system.

13. A system according to claim 1, wherein the docking station is a lamp.

14. A system according to claim 13, wherein the lamp comprises three types of light:
signaling type;
focus type;
ambient type.

15. A system according to claim 13, wherein light intermittence is used as means to convey information to a user.

16. A system according to claim 13, wherein variations in light intensity are used as means to convey information to a user.

17. A system according to claim 14, wherein signaling light is used to indicate motion of the lamp structure to a user.

18. A lamp comprising three types of light:
signaling type;
focus type;
ambient type.

19. A lamp according to claim 18, wherein light intermittence is used as means to convey information to a user.

20. A lamp according to claim 18, wherein variations in light intensity are used as means to convey information to a user.

21. A lamp according to claim 18, wherein signaling light is used to indicate motion of the lamp structure to a user.
